(19) United States
(12) Patent Application Publication
(10) Pub. No.: US 2023/0376725 A1
(43) Pub. Date: Nov. 23, 2023

(54) MODEL CUSTOMIZATION OF TRANSFORMERS FOR IMPROVED EFFICIENCY

(71) Applicant: Microsoft Tachnology Licensing, LLC, Redmond, WA (US)

(72) Inventors: Maral Mesmakhosroshahi, Mountain View, CA (US); Bita Darvish Rouhani, Bellevue, WA (US); Eric S. Chung, Woodinville, WA (US); Douglas C. Burger, Bellevue, WA (US); Maximilian Taylor Golub, Seattle, WA (US)

(21) Appl. No.: 17/748,912

(22) Filed: May 19, 2022

(51) Int. Cl. G06N 3/04; G06N 3/08

(52) U.S. Cl. CPC G06N 3/04; G06N 3/08

(57) ABSTRACT

Embodiments of the present disclosure include systems and methods for providing model customizations of transformers for improved efficiency. A first set of settings for a transformer model is received. Based on the first set of settings, a second set of settings for the transformer model is determined. The first set of settings and the second set of settings are used to configure and train the transformer model.

### BACKGROUND

The present disclosure relates to computing hardware. More particularly, the present disclosure relates to techniques for training neural networks.

Natural-language understanding (NLU) is a subfield of natural-language processing (NLP) in artificial intelligence that addresses comprehension by computers of the structure and meaning of human language. NLU enables voice technology, search engines, and machine translation to deduce what a user means, regardless of the way it is expressed

A neural network is a machine learning model that underpins NLU applications. A neural network is trained for a particular purpose by running datasets through it, comparing results from the neural network to known results, and updating the network based on the differences.

### BRIEF DESCRIPTION OF THE DRAWINGS

Various embodiments of the present disclosure are illustrated by way of example and not limitation in the figures of the accompanying drawings.

FIG. 1 illustrates a system for providing model customization of transformers for improved efficiency according to some embodiments.

FIG. 2 illustrates language model loss as a function of sparsity according to some embodiments.

FIG. 3 illustrates language model loss as a function of model density according to some embodiments.

FIG. 4 illustrates an example of determining model settings according to some embodiments.

FIG. 5 illustrates another example of determining model settings according to some embodiments.

FIG. 6 illustrates another example of determining model settings according to some embodiments.

FIG. 7 illustrates another example of determining model settings according to some embodiments.

FIG. 8 illustrates a process for providing model customizations of transformers according to some embodiments.

FIG. 9 depicts a simplified block diagram of an example computer system according to some embodiments.

FIG. 10 illustrates a neural network processing system according to some embodiments.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Described here are techniques for providing model customizations of transformers for improved efficiency. In some embodiments, a computing system may receive a first set of model settings for a transformer model. Based on the first set of model settings, the computing system determines a second set of model settings for the transformer model. The first and second set of model settings can be used to configure and train the transformer model. The computing system can determine different second sets of model settings for different first sets of model settings. For instance, when the first set of model parameters includes a model topology (e.g., number of layers, size of a hidden dimension, etc.) and a number of tokens to use to train the transformer model, the computing system may determine a density level to use for parameters in the transformer model. As another example, if the computing system receives a defined number of non-zero parameters in the transformer model and a number of tokens to use to train the transformer model as the first set of model settings, the computing system can determine a number of layers, a size of a hidden dimension, and a density level for the transformer model. In cases where the computing system receives, as the first set of model settings, a defined density level, a ratio between a size of a hidden dimension of the transformer model and a number of layers in the transformer model, and a number of tokens to use to train the transformer model, the computing system may determine a number of parameters to use for the transformer model as well as the size of the hidden dimension and the number of layers to use for the transformer model. If the computing system receives a defined model topology and a defined density value for the first set of model settings, the computing system can determine a number of tokens to use to train the transformer model.

The techniques described in the present application provide a number of benefits and advantages over conventional methods of training transformer models. For example, applying sparsification techniques to parameters of a transformer model allows the transformer model to be trained using less computing resources but maintain the same/similar amount of loss. Conventional methods that do not utilize sparsification techniques on parameters of the transformer model achieve the same/similar amount of loss but utilize more computing resources to train the transformer model.

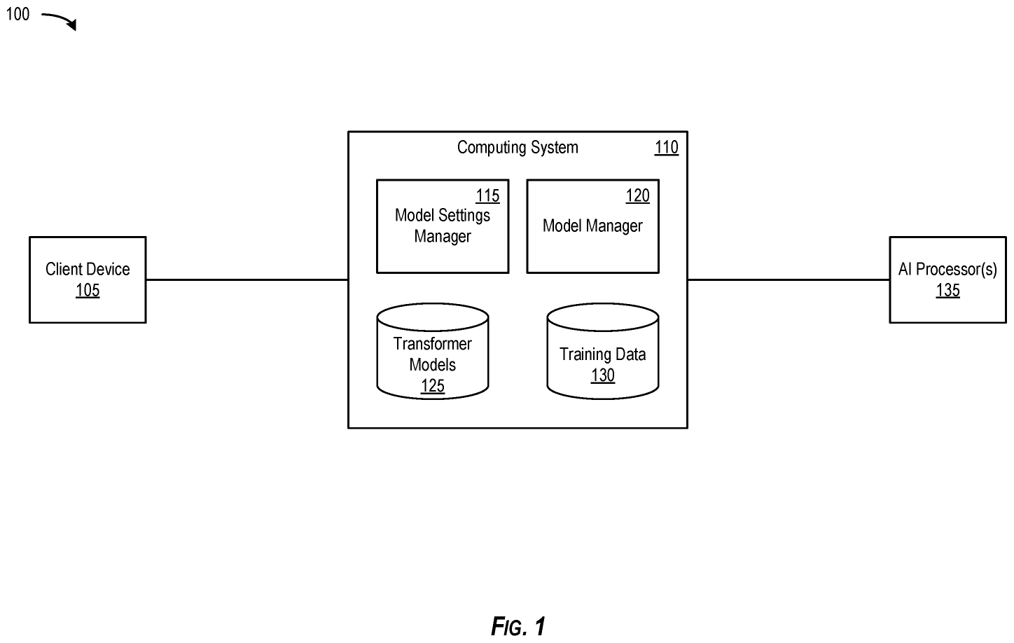

FIG. 1 illustrates a system 100 for providing model customization of transformers for improved efficiency according to some embodiments. As shown, system 100 includes client device 105, computing system 110, and artificial intelligence (AI) processor(s) 135. Client device 105 is configured to interact with computing system 110. For example, a user of client device 105 may provide computing system 110 a first set of model settings for a transformer model. In return, client device 105 receives from computing system 110 a second set of model settings. Then, the user of client device 105 provides computing system 110 the first and second sets of model settings to configure a transformer model and train the transformer model.

As illustrated in FIG. 1, computing system 110 includes model settings manager 115, model manager 120, transformer models storage 125, and training data storage 130. Transformer models storage 125 stores transformer models while training data storage 130 stores training data for training transformer models. In some embodiments, a transformer model is a machine learning model that includes a set of layers and a self-attention mechanism (e.g., self-attention heads). In some such embodiments, each layer of a transformer model includes a set of self-attention heads. In some embodiments, storages 125 and 130 are implemented in a single physical storage while, in other embodiments, storages 125 and 130 may be implemented across several physical storages. While FIG. 1 shows storages 125 and 130 as part of computing system 110, one of ordinary skill in the art will appreciate that transformer models storage 125 and/or training data storage 130 may be external to computing system 110 in some embodiments.

Model settings manager 115 is configured to manage model settings for transformer models. For instance, model settings manager 115 can receive a first set of model settings (e.g., from client device 105). In response, model settings manager 115 determines a second set of model settings. In some cases, model settings manager 115 sends client device 105 the second set of model settings. In other cases, model settings manager 115 sends the first and second sets of model settings to model manager 120 for further processing.

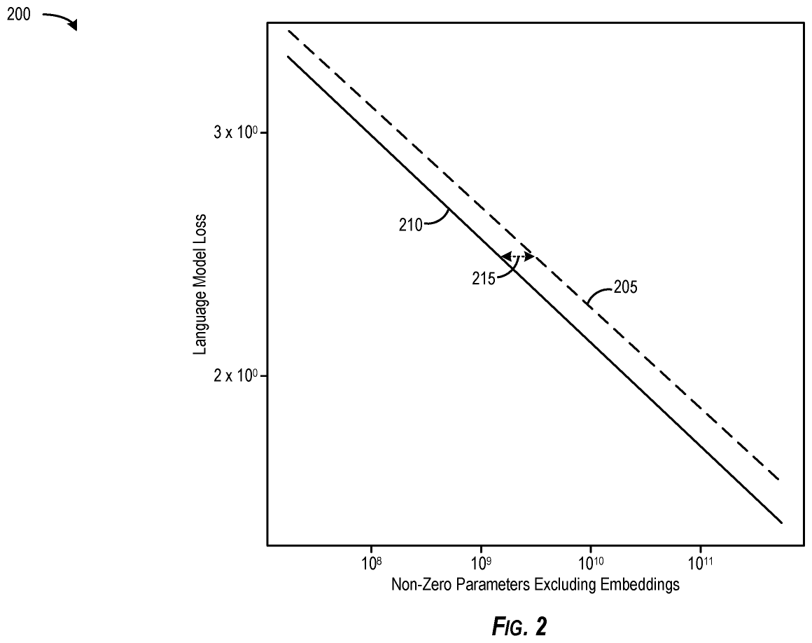

In some embodiments, model settings manager 115 determines a second set of model settings for a given first set of model settings by introducing parameter sparsity as a variable for configuring transformer models and leveraging the efficiency gained from parameter sparsity to determine other model settings. A sparsity scaling principle will now be explained to demonstrate the efficiency gained from parameter sparsity. FIG. 2 illustrates language model loss as a function of sparsity according to some embodiments. Specifically, FIG. 2 illustrates chart 200 that conceptually depicts language model loss as a function of model parameter sparsity. As shown, chart 200 includes dense pareto fronter 205, which shows the relationship between non-zero parameters (excluding embedding parameters) in a transformer model and language model loss for the transformer model once it has been trained. As the number of non-zero parameters decreases, the language model loss increases. Chart 200 also includes sparse pareto frontier 210. Sparse pareto frontier 210 shows the relationship between non-zero parameters (excluding embedding parameters) in a transformer model that has been sparsified and language model loss for the sparsified transformer model after it has been trained. As shown, a dense transformer model with a given number of non-zero parameters and a sparsified transformer model that includes less non-zero parameters than the dense transformer model achieves the same language model loss. In effect, the sparsified transformer model is able to achieve the same language model loss as the corresponding dense transformer model but the sparsified transformer model is able to do so using less computing resources. Efficiency gain 215, as shown in chart 200, may refer to the difference between non-zero parameters in a sparsified transformer model and a corresponding dense transformer model for a given language model loss.

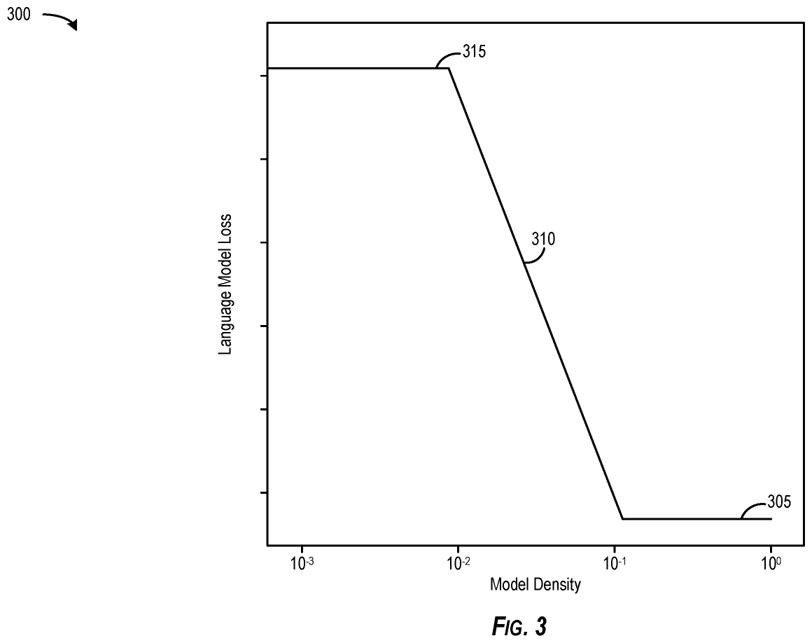

FIG. 3 illustrates language model loss as a function of model density according to some embodiments. In particular, FIG. 3 illustrates chart 300 that conceptually shows language model loss as a function of model density. As depicted, chart 300 includes three regions 305-315. In region 305 (also referred to as a low-error plateau), a sparsified transformer model has the same/similar accuracy as a corresponding dense transformer model. In region 310 (also referred to as a power-law region), a linear correlation exists between language model loss and model density (e.g., density=1−sparsity) in logarithmic scale. The transition point from the low-error plateau to the power-law region can be defined as the critical density level. In region 315 (also referred to as a high-error plateau), a sparsified transformer model has the same/similar accuracy as a dense initialized transformer model.

To quantify the efficiency gain for transformer models, the following formula (1) is used:

$${L}_{dense} = {( \frac{{N}_{c}}{{N}_{total}} )}^{{α}_{N}}$$

where Nₜₒₜₐₗ is the total number of parameters in a dense transformer model excluding vocabulary and positional parameters, α_{N} is a power-law exponent for the scaling of the dense loss as a function of Nₜₒₜₐₗ, L_{dense} is the loss of the transformer model of size Nₜₒₜₐₗ, and N_{c} is a constant scale correlating L_{dense}, Nₜₒₜₐₗ, and α_{N}. In some embodiments, N_{c} is equal to 8.8×10¹³ non-embed params and α_{N} is equal to 0.076. In some embodiments, Nₜₒₜₐₗ can be estimated as 12*H²*n_{layer} where H is the size of a hidden dimension of the transformer model and n_{layer} is the depth of the transformer model (e.g., number of layers).

For the purpose of quantifying the efficiency gain, region 315 will be ignored. The following equation (2) can be used to model regions 305 and 310 in chart 300:

$${L}_{sparse} = {L}_{dense} \times {( \frac{{d}^{β} + {d}_{c r}^{β}}{{d}^{β}} )}^{\frac{Y}{β}}$$

where d is the density level of a transformer model, d_{cr} is the critical density level mentioned above, β is a constant equal to the value 4, γ is the slope in the sparse power-law region mentioned above, and Lₛₚₐᵣₛₑ is the loss of the transformer model after it has been sparsified to the density level d. Here, the value of d may be between [0-1] with a density of 1 indicating zero sparsity (e.g., the model is dense). Equation (2) may be rewritten as the following equations (3)-(6):

$$\begin{matrix}{L}_{sparse} & = {( \frac{{N}_{c}}{{N}_{total}^{′}} )}^{{α}_{N}} \times {( \frac{{d}^{β} + {d}_{c r}^{β}}{{d}^{β}} )}^{\frac{Y}{β}} \\ & = {( ( \frac{{N}_{c}}{{N}_{total}^{′} \times d} ) \times d \times {( \frac{{d}^{β} + {d}_{c r}^{β}}{{d}^{β}} )}^{\frac{Y}{β}} )}^{{α}_{N}} \\ & = {( \frac{{N}_{c}}{12 {H}^{2} {n}_{layers}} )}^{{α}_{N}} \times {( \frac{{d}^{β} + {d}_{c r}^{β}}{{d}^{β}} )}^{\frac{{α}_{γ} {n}_{layer}^{{β}_{n}} {H}^{{β}_{h}} {T}^{{β}_{t}}}{β}} \\ & = {( \frac{{N}_{c}}{{N}_{total}} )}^{{α}_{N}} \times {( \frac{{d}^{β} + {d}_{c r}^{β}}{{d}^{β}} )}^{\frac{{α}_{γ}^{′} {n}_{layer}^{{β}_{{n}_{l}}^{′}} {N}_{total}^{{β}_{{n}_{t}}^{′}} {T}^{{β}_{t}}}{β}}\end{matrix}$$

Next, the efficiency gain may be defined according to the following equation (7):

$${eff}_{gain} = \frac{{N}_{total}}{{N}_{total}^{′} \times d} = \frac{1}{{d ( \frac{{d}^{β} + {d}_{c r}^{β}}{{d}^{β}} )}^{\frac{γ}{{α}_{N}}}}$$

where N′ₜₒₜₐₗ is the total number of parameters in a transformer model excluding the embedding parameters and eff_{gain} is the efficiency gain. Equation (7) can be rewritten as the following equations (8) and (9):

$$\begin{matrix}{eff}_{gain} & = \frac{1}{{d ( \frac{{d}^{β} + {d}_{c r}^{β}}{{d}^{β}} )}^{\frac{{α}_{γ} {n}_{layer}^{{β}_{n}} {H}^{{β}_{h}} {T}^{{β}_{t}}}{{α}_{N}}}} \\ & = \frac{1}{{d ( \frac{{d}^{β} + {d}_{c r}^{β}}{{d}^{β}} )}^{\frac{{α}_{γ}^{′} {n}_{layer}^{{β}_{{n}_{l}}^{′}} {N}_{total}^{{β}_{{n}_{t}}^{′}} {T}^{{β}_{t}}}{{α}_{N}}}}\end{matrix}$$

Now assuming that γ and d_{cr} are independent of the density level of a model (d), eff_{gain} can be maximized at the following equations (10) and (11):

$$\frac{\partial ( {eff}_{gain} )}{\partial d} = 0$$

$$\frac{\partial ( {eff}_{gain} )}{\partial d} = \frac{( ( \frac{γ}{{α}_{N}} ) ( \frac{{d}_{c r}^{β}}{{d}^{β}} ) ( 1 + {( \frac{{d}_{c r}^{β}}{{d}^{β}} )}^{- 1} ) - 1 )}{{{d}^{β} ( 1 + {( \frac{{d}_{c r}^{β}}{{d}^{β}} )}^{β} )}^{\frac{γ}{2 {α}_{N}}}} = 0$$

The optimal density level can be determined using the following equations (12) and (13):

$$\begin{matrix}{d}_{opt} & = {d}_{cr} \sqrt[β]{\frac{γ - {α}_{N}}{{α}_{N}}} & for 2 {α}_{N} > γ > {α}_{N} \\ {d}_{opt} & = {d}_{cr} & for γ \leq {α}_{N} and γ \geq 2 {α}_{N}\end{matrix}$$

where dₒₚₜ is the optimal density level for a transformer model. Depending on the model topology (e.g., number of layers, size of hidden dimension, a ratio between the number of layers and the size of hidden dimension (also referred to as the aspect ratio, etc.) the optimal density level changes. In some embodiments, γ is a function of the number of layers in a transformer model, the size of a hidden dimension, and the number of tokens to use to train the transformer model. Such a function may be modeled using the following equation (14):

$$γ = {a}_{γ} {n}_{layer}^{{β}_{n}} {H}^{{β}_{h}} {T}^{{β}_{t}} = {a}_{γ}^{′} {n}_{layer}^{{β}_{{n}_{l}}^{′}} {N}_{total}^{{β}_{{n}_{t}}^{′}} {T}^{{β}_{t}}$$

where α_{γ}=0.002, βₙ=0.089, βₕ=0.041, and βₜ=0.127, H is the size of a hidden dimension of a transformer model, and T is the number of tokens to use to train the transformer model. In some embodiments, d_{cr} is a function of transformer model width (e.g., the size of a hidden dimension) and the aspect ratio (e.g., H/n_{layer}). The aspect ratio can control the y-intercept (and not the slope) in the log-log scale. In some embodiments, the slope may be modeled by analyzing transformer models of a fixed aspect ratio. Once the slope is quantified, the y-intercept can be modeled by analyzing a few datapoints with different aspect ratios (e.g., fixing the slope between different fits) using the following equation (15):

$${d}_{cr} = {a}_{{d}_{cr}} H {α}_{toke} T such that {d}_{cr} > {d}_{random}$$

Model manager 120 is responsible for managing transformer models. For example, model manager 120 may receive a first set of model settings and a second set of model settings (e.g., from client device 105, from model settings manager 115, etc.). In response, model manager 120 generates, configures, and trains a transformer model based on the received first and second sets of model settings. Model manager 120 can train a transformer model using AI processor(s) 135 and training data retrieved from training data storage 130. After a transformer model is trained, model manager 120 can store the trained transformer model in transformer models storage 125.

AI processor(s) 135 is hardware configured to implement and execute transformer models. AI processor(s) 135 may include graphics processors (GPUs), AI accelerators, or other digital processors optimized for AI operations. For instance, AI processor(s) 135 may receive a transformer model and a set of training data. In response, AI processor(s) 135 trains the transformer model using the set of training data.

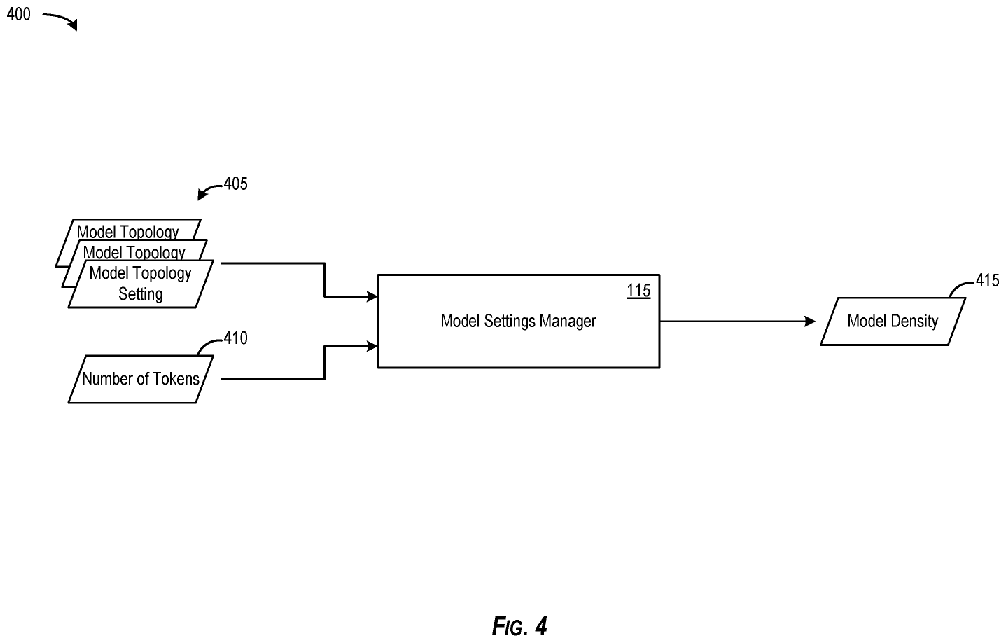

Several example operations will now be described by reference to FIGS. 4-7. Specifically, these example operations demonstrate how model settings manager 115 may determine different sets of model settings for different given sets of model settings. FIG. 4 illustrates a first example of determining model settings according to some embodiments. For this example, model settings manager 115 receives (e.g., from client device 105, a service or application operating on computing system 110 or other computing device/system, etc.) a set of model topology settings 405 for a transformer model and a number of tokens setting 410 to use to train the transformer model. In some embodiments, the set of model topology settings 405 can include a depth of the transformer model (e.g., number of layers in the transformer model) and the size of a hidden dimension of the transformer model. When model settings manager 115 receives these model settings, model settings manager 115 uses equations (12) and (13) to determine an optimal density level 415 for the transformer model. Model settings manager 115 sends the set of model topology settings 405, the number of tokens setting 410, and the optimal model density level 415 to model manager 120. Upon receiving these settings, model manager 120 generates and configures a transformer model that has the settings specified in the set of model topology settings 405. In addition, model manager 120 applies a sparsification technique to sparsify the parameters of the transformer model to the optimal density level 415. Then, model manager 120 instructs AI processor(s) 135 to implement the transformer model and train it using the number of tokens specified in setting 410. AI processor(s) 135 retrieves the requested number of tokens from training data storage 130 and trains the transformer model. Once the transformer model is trained, model manager 120 may store it in transformer models storage 125 for later use for inferencing.

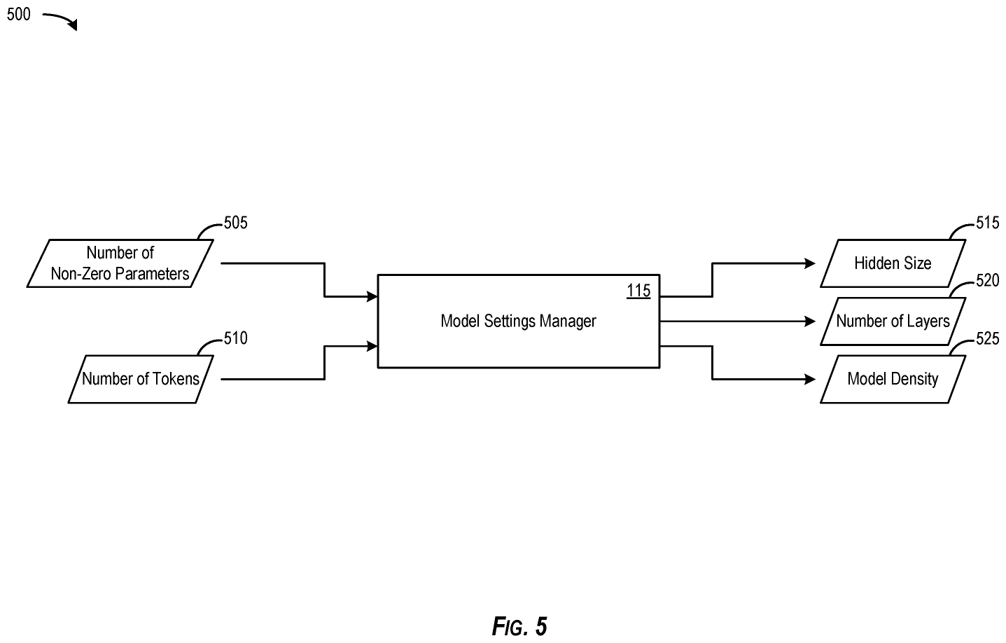

FIG. 5 illustrates a second example of determining model settings according to some embodiments. As shown in FIG. 5, in this example, model settings manager 115 receives (e.g., from client device 105, a service or application operating on computing system 110 or other computing device/system, etc.) a number of non-zero parameters setting 505 for a transformer model and a number of tokens setting 510 to use to train the transformer model. Once model settings manager 115 receives the model settings, model settings manager 115 uses equation (9) to determine a size of a hidden dimension 515, a number of layers 520, a density level 525 for the transformer model. Here, model settings manager 115 can utilize a multi-objective optimization function on equation (9) to determine settings 515-525. Next, model settings manager 115 sends the number of non-zero parameters setting 505, the number of tokens setting 510, the size of a hidden dimension 515, the number of layers 520, and the density level 525 to model manager 120. When model manager 120 receives the settings, model manager 120 generates and configures a transformer model that has a hidden dimension having the size specified in setting 515 and a number of layers specified in setting 520. Model manager 120 then applies a sparsification technique to sparsify the parameters of the transformer model to have the number of non-zero parameters specified in setting 505 and at the density level specified in setting 525. Model manager 120 continues by instructing AI processor(s) 135 to implement the transformer model and train it using the number of tokens specified in setting 510. AI processor(s) 135 retrieves the requested number of tokens from training data storage 130 and trains the transformer model. After training is complete, model manager 120 can store the transformer model in transformer models storage 125 for later use for inferencing.

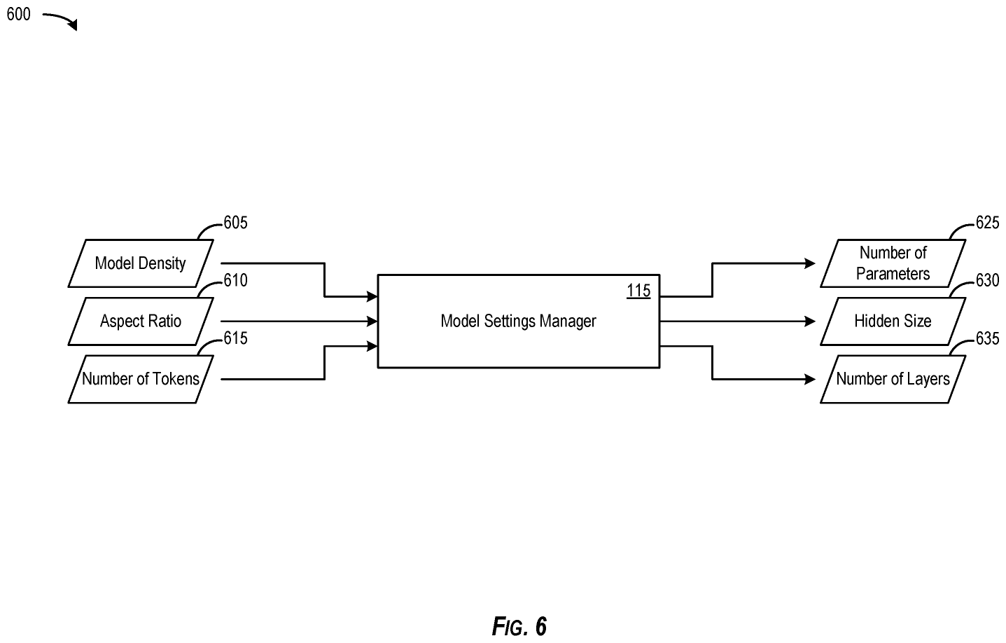

FIG. 6 illustrates a third example of determining model settings according to some embodiments. For this example, model settings manager 115 receives (e.g., from client device 105, a service or application operating on computing system 110 or other computing device/system, etc.) a density level setting 605 for a transformer model, an aspect ratio setting 610, and a number of tokens setting 615 to use to train the transformer model. In this example, the aspect ratio is defined as the size of the hidden dimension of the transformer model divided by the number of layers in the transformer model (i.e., H/n_{layer}). When model settings manager 115 receives these model settings, model settings manager 115 uses equation (9) to determine a number of parameters 625, a size of a hidden dimension 630, and a number of layers 635 for the transformer model. For this example, model settings manager 115 may apply a multi-objective optimization function to equation (9) to determine settings 625-635. Model settings manager 115 sends the density level setting 605, the aspect ratio setting 610, the number of tokens setting 615, the number of parameters 625, the size of a hidden dimension 630, and the number of layers 635 to model manager 120. Upon receiving these settings, model manager 120 generates and configures a transformer model that has a hidden dimension having the size specified in setting 630, a number of layers specified in setting 635, and an aspect ratio specified in setting 610. Model manager 120 then applies a sparsification technique to sparsify the parameters of the transformer model to have the number of non-zero parameters specified in setting 625 and at the density level specified in setting 605. Next, model manager 120 instructs AI processor(s) 135 to implement the transformer model and train it using the number of tokens specified in setting 615. AI processor(s) 135 retrieves the requested number of tokens from training data storage 130 and trains the transformer model. Once the transformer model is trained, model manager 120 may store it in transformer models storage 125 for later use for inferencing.

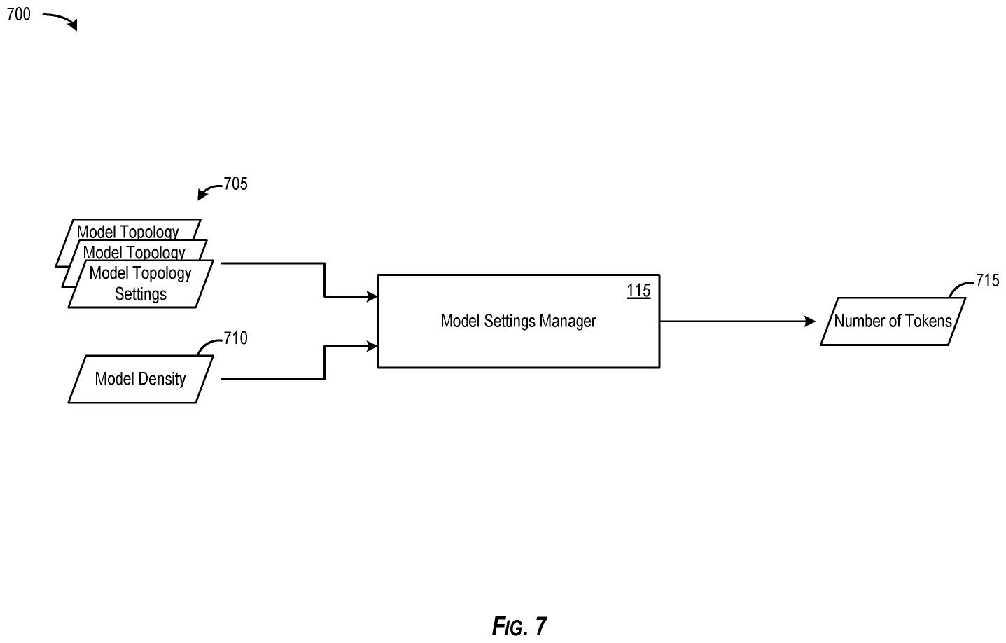

FIG. 7 illustrates a fourth example of determining model settings according to some embodiments. In this example, model settings manager 115 receives (e.g., from client device 105, a service or application operating on computing system 110 or other computing device/system, etc.) a set of model topology settings 705 and a density level setting 710 for a transformer model. In some embodiments, the set of model topology settings 705 can include a depth of the transformer model (e.g., number of layers in the transformer model) and the size of a hidden dimension of the transformer model. Once model settings manager 115 receives the model settings, model settings manager 115 uses equation (9) to determine a number of tokens 715 to use to train the transformer model. Next, model settings manager 115 sends the set of model topology settings 705, the density level setting 710, and the number of tokens 715 to model manager 120. When model manager 120 receives the settings, model manager 120 generates and configures a transformer model that has the settings specified in the set of model topology settings 705. Model manager 120 then applies a sparsification technique to sparsify the parameters of the transformer model to the density level specified in setting 710. Model manager 120 continues by instructing AI processor(s) 135 to implement the transformer model and train it using the number of tokens specified in setting 715. AI processor(s) 135 retrieves the requested number of tokens from training data storage 130 and trains the transformer model. After training is complete, model manager 120 can store the transformer model in transformer models storage 125 for later use for inferencing.

As mentioned above, FIG. 2 illustrates chart 200 that conceptually depicts language model loss as a function of model parameter sparsity. Additionally, the equation (9) provided above is a function of multiple variables (e.g., size of a hidden dimension of a transformer model, a number of layers in the transformer model, a density level of parameters in the transformer model, a number of tokens to use to train the transformer model, etc.). As such, a multi-objective optimization function can be used to calculate sparse pareto frontier 210 shown in FIG. 1. The multi-objective optimization function may maximize the efficiency gain with respect to the multiple variables.

The example operations described above by reference to FIGS. 4-7 utilize a sparsification technique to sparsify a transformer model. One of ordinary skill in the art will understand that any number of different sparsification techniques (e.g., a dynamic magnitude pruning technique) can be used to sparsify transformer models.

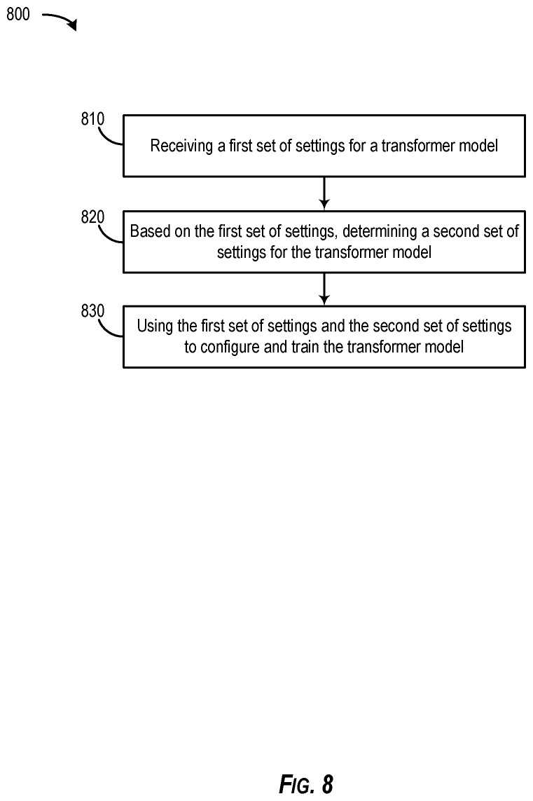

FIG. 8 illustrates a process 800 for providing model customizations of transformers according to some embodiments. In some embodiments, computing system 110 performs process 800. Process 800 begins by receiving, at 810, a first set of settings for a transformer model. Referring to FIGS. 1 and 4 as an example, model settings manager 115 can receive (e.g., from client device 105) the first set of settings (e.g., a set of model topology settings 405 for a transformer model and a number of tokens setting 410).

Next, based on the first set of settings, process 800 determines, at 820, a second set of settings for the transformer model. Referring to FIGS. 1 and 4 as an example, model settings manager 115 determines a second set of settings (e.g., an optimal density level 415) based on the first set of settings.

Finally, process 800 uses, at 830, the first set of settings and the second set of settings to configure and train the transformer model. Referring to FIGS. 1 and 4 as an example, model manager 120 can generate and configure a transformer model that has the settings specified in the set of model topology settings 405. In addition, model manager 120 may apply a sparsification technique to sparsity the parameters of the transformer model to the optimal density level 415. Model manager 120 then instructs AI processor(s) 135 to implement the transformer model and train it using the number of tokens specified in setting 410.

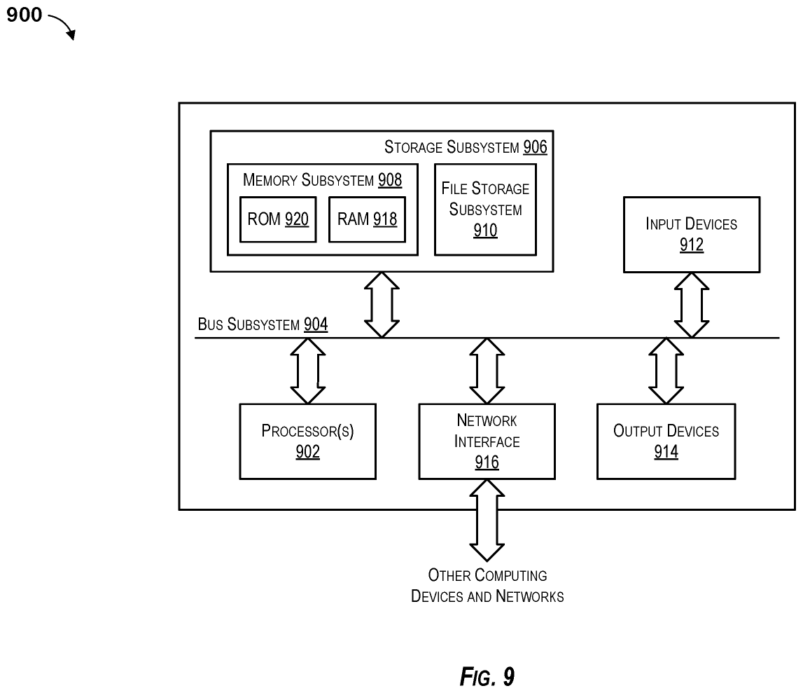

The techniques describe above may be implemented in a wide range of computer systems configured to process neural networks. FIG. 9 depicts a simplified block diagram of an example computer system 900, which can be used to implement the techniques described in the foregoing disclosure. For instance, computer system 900 may be used to implement client device 105 and computing system 110. As shown in FIG. 9, computer system 900 includes one or more processors 902 that communicate with a number of peripheral devices via a bus subsystem 904. These peripheral devices may include a storage subsystem 906 (e.g., comprising a memory subsystem 908 and a file storage subsystem 910) and a network interface subsystem 916. Some computer systems may further include user interface input devices 912 and/or user interface output devices 914.

Bus subsystem 904 can provide a mechanism for letting the various components and subsystems of computer system 900 communicate with each other as intended. Although bus subsystem 904 is shown schematically as a single bus, alternative embodiments of the bus subsystem can utilize multiple busses.

Network interface subsystem 916 can serve as an interface for communicating data between computer system 900 and other computer systems or networks. Embodiments of network interface subsystem 916 can include, e.g., Ethernet, a Wi-Fi and/or cellular adapter, a modem (telephone, satellite, cable, ISDN, etc.), digital subscriber line (DSL) units, and/or the like.

Storage subsystem 906 includes a memory subsystem 908 and a file/disk storage subsystem 910. Subsystems 908 and 910 as well as other memories described herein are examples of non-transitory computer-readable storage media that can store executable program code and/or data that provide the functionality of embodiments of the present disclosure.

Memory subsystem 908 includes a number of memories including a main random access memory (RAM) 918 for storage of instructions and data during program execution and a read-only memory (ROM) 920 in which fixed instructions are stored. File storage subsystem 910 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 900 is illustrative and many other configurations having more or fewer components than system 900 are possible.

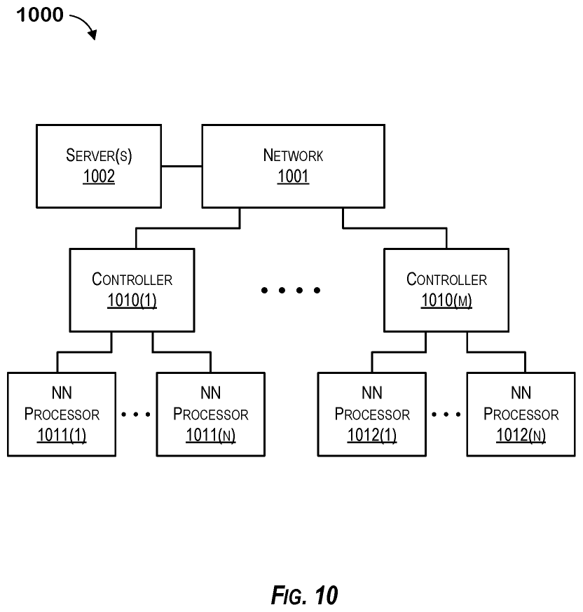

FIG. 10 illustrates a neural network processing system according to some embodiments. In various embodiments, neural networks according to the present disclosure may be implemented and trained in a hardware environment comprising one or more neural network processors. A neural network processor may refer to various graphics processing units (GPU) (e.g., a GPU for processing neural networks produced by Nvidia Corp®), field programmable gate arrays (FPGA) (e.g., FPGAs for processing neural networks produced by Xilinx®), or a variety of application specific integrated circuits (ASICs) or neural network processors comprising hardware architectures optimized for neural network computations, for example. In this example environment, one or more servers 1002, which may comprise architectures illustrated in FIG. 9 above, may be coupled to a plurality of controllers 1010(1)-1010(M) over a communication network 1001 (e.g., switches, routers, etc.). Controllers 1010(1)-1010(M) may also comprise architectures illustrated in FIG. 9 above. Each controller 1010(1)-1010(M) may be coupled to one or more NN processors, such as processors 1011(1)-1011(N) and 1012(1)-1012(N), for example. In some embodiments, NN processors 1011(1)-1011(N) and 1012(1)-1012(N) may be used to implement AI processor(s) 135. NN processors 1011(1)-1011(N) and 1012(1)-1012(N) may include a variety of configurations of functional processing blocks and memory optimized for neural network processing, such as training or inference. The NN processors are optimized for neural network computations. Server 1002 may configure controllers 1010 with NN models as well as input data to the models, which may be loaded and executed by NN processors 1011(1)-1011(N) and 1012(1)-1012(N) in parallel, for example. Models may include layers and associated weights as described above, for example. NN processors may load the models and apply the inputs to produce output results. NN processors may also implement training algorithms described herein, for example.

### Further Example Embodiments

In various embodiments, the present disclosure includes systems, methods, and apparatuses for providing model customizations of transformers for improved efficiency. The techniques described herein may be embodied in non-transitory machine-readable medium storing a program executable by a computer system, the program comprising sets of instructions for performing the techniques described herein. In some embodiments, a system includes a set of processing units and a non-transitory machine-readable medium storing instructions that when executed by at least one processing unit in the set of processing units cause the at least one processing unit to perform the techniques described above. In some embodiments, the non-transitory machine-readable medium may be memory, for example, which may be coupled to one or more controllers or one or more artificial intelligence processors, for example.

The following techniques may be embodied alone or in different combinations and may further be embodied with other techniques described herein.

For example, in one embodiment, the present disclosure includes a method comprising receiving a first set of settings for a transformer model; based on the first set of settings, determining a second set of settings for the transformer model; and using the first set of settings and the second set of settings to configure and train the transformer model.

In one embodiment, the first set of settings comprises a set of settings associated with a topology of the transformer model.

In one embodiment, the set of settings comprises a number of layers of the transformer model.

In one embodiment, the set of settings comprises a size of a hidden dimension of the transformer model.

In one embodiment, the first set of settings further comprises a number of tokens for training the transformer model.

In one embodiment, the second set of settings comprises a density value for a plurality parameters in the transformer model.

In one embodiment, using the first set of settings and the second set of settings to configure and train the transformer model comprises applying a sparsity technique to the plurality of parameters of the transformer model.

In one embodiment, the first set of settings further comprises a density value for a plurality of parameters in the transformer model.

In one embodiment, the second set of settings comprises a number of tokens for training the transformer model.

In one embodiment, the first set of settings comprises a number of non-zero parameters in the transformer model, a number of tokens for training the transformer model, and a size of a hidden dimension of the transformer model.

In one embodiment, the second set of settings further comprises a number of layers of the transformer model.

In one embodiment, the second set of settings further comprises a density value for a plurality of parameters in the transformer model.

In one embodiment, using the first set of settings and the second set of settings to configure and train the transformer model comprises applying a sparsity technique to the plurality of parameters of the transformer model.

In one embodiment, the first set of settings comprises a density value for a plurality of parameters in the transformer model, a ratio between a size of a hidden dimension of the transformer model and a number of layers of the transformer model, and a number of tokens for training the transformer model.

In one embodiment, the second set of settings comprises a number of parameters in the transformer model.

In one embodiment, the transformer model is a first transformer model. The present disclosure further determines a first loss value for the first transformer model and determines a second loss value for a second transformer model. Determining the second set of settings for the transformer model is based on a ratio between the first loss value and the second loss value.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A non-transitory machine-readable medium storing a program executable by at least one processing unit of a device, the program comprising sets of instructions for:
receiving a first set of settings for a transformer model;
based on the first set of settings, determining a second set of settings for the transformer model; and
using the first set of settings and the second set of settings to configure and train the transformer model.

2. The non-transitory machine-readable medium of claim 1, wherein the first set of settings comprises a set of settings associated with a topology of the transformer model.

3. The non-transitory machine-readable medium of claim 2, wherein the set of settings comprises a number of layers of the transformer model.

4. The non-transitory machine-readable medium of claim 2, wherein the set of settings comprises a size of a hidden dimension of the transformer model.

5. The non-transitory machine-readable medium of claim 2, wherein the first set of settings further comprises a number of tokens for training the transformer model.

6. The non-transitory machine-readable medium of claim 5, wherein the second set of settings comprises a density value for a plurality parameters in the transformer model.

7. The non-transitory machine-readable medium of claim 6, wherein using the first set of settings and the second set of settings to configure and train the transformer model comprises applying a sparsity technique to the plurality of parameters of the transformer model.

8. The non-transitory machine-readable medium of claim 2, wherein the first set of settings further comprises a density value for a plurality of parameters in the transformer model.

9. The non-transitory machine-readable medium of claim 8, wherein the second set of settings comprises a number of tokens for training the transformer model.

10. The non-transitory machine-readable medium of claim 1, wherein the first set of settings comprises a number of non-zero parameters in the transformer model, a number of tokens for training the transformer model, and a size of a hidden dimension of the transformer model.

11. The non-transitory machine-readable medium of claim 10, wherein the second set of settings further comprises a number of layers of the transformer model.

12. The non-transitory machine-readable medium of claim 10, wherein the second set of settings further comprises a density value for a plurality of parameters in the transformer model.

13. The non-transitory machine-readable medium of claim 12, wherein using the first set of settings and the second set of settings to configure and train the transformer model comprises applying a sparsity technique to the plurality of parameters of the transformer model.

16. The non-transitory machine-readable medium of claim 1, wherein the first set of settings comprises a density value for a plurality of parameters in the transformer model, a ratio between a size of a hidden dimension of the transformer model and a number of layers of the transformer model, and a number of tokens for training the transformer model.

17. The non-transitory machine-readable medium of claim 16, wherein the second set of settings comprises a number of parameters in the transformer model.

18. A system comprising:
a set of processing units; and
a non-transitory machine-readable medium storing instructions that when executed by at least one processing unit in the set of processing units cause at least one processing unit to:
receive a first set of settings for a transformer model;
based on the first set of settings, determine a second set of settings for the transformer model; and
use the first set of settings and the second set of settings to configure and train the transformer model.

19. The system of claim 18, wherein the transformer model is a first transformer model, wherein the instructions further cause the at least one processing unit to:
determine a first loss value for the first transformer model; and
determine a second loss value for a second transformer model,
wherein determining the second set of settings for the transformer model is based on a ratio between the first loss value and the second loss value.

20. A method comprising:
receiving a first set of settings for a transformer model;
based on the first set of settings, determining a second set of settings for the transformer model; and
using the first set of settings and the second set of settings to configure and train the transformer model.
